(19) United States
(12) Patent Application Publication
(10) Pub. No.: US 2003/0226478 A1
(43) Pub. Date: Dec. 11, 2003

(54) Modular structure for furniture

(75) Inventor: Bruno Nicoletti, Calderino di Monte S. Pietro (IT)

Correspondence Address: WILLIAM J. SAPONE, COLEMAN SUDOL SAPONE P.C., 714 COLORADO AVENUE, BRIDGE PORT, CT, 06605, US

(73) Assignee: METAL WORK S.r.l., Calderino di Monte S. Pietro (IT)

(21) Appl. No.: 10/456,740

(22) Filed: Jun. 6, 2003

(30) Foreign Application Priority Data
Jun. 7, 2002 (IT) BO2002A 000356

(51) Int. Cl. A47B 37/00; F16M 11/20; A47B 97/00

(52) U.S. Cl. 108/50.02; 312/223.6; 248/188.1

(57) ABSTRACT

A modular structure for furniture includes a tubular post formed by a pair of channel-bars disposed so that one faces the other and secured to each other by a base plate and a cross-bar. A series of longitudinal grooves, namely internal grooves made in the inner walls of the channel-bars, and external grooves made on the outer walls of the channel-bars. A support leg extends diagonally from an upper part of the post and is connected to the post by means of a connection member engaging one of the external grooves of the post. The cross-bar is formed by a “U”-shaped bar with an open side turned upwards, so as to form a channel closed at top by a cover element. The base plate and the cross-bar are connected to the post by means of connection pegs engaging the internal groove of the post. A bracket for supporting a working surface is fastened at bottom of the cross-bar by a clamp. A pair of counter-facing sides are joined to the post with a snap fit.

### TECHNICAL FIELD

The present invention relates to a modular structure for furniture.

### BACKGROUND OF THE INVENTION

It is known that typical current furniture, such as, in particular, office furniture, should be made with modular characteristics, such that they can be mounted in accordance with the need of the buyer.

In the specific case of office furniture, there is in particular the necessity of forming individual and multiple work stations inside the same room. The work stations in this way formed must obviously be provided with power plugs and similar devices, in order to allow easy use of the conventional apparatuses.

### SUMMARY OF THE INVENTION

The object of the present invention is to solve the above mentioned problem, by providing a modular structure capable of forming easily modular furniture, in particular for offices and the like.

Within the scope of the above mentioned task, it is a further object of the present invention to provide a modular structure allowing formation of modular custom-designed furniture.

A further object of the present invention is that of providing a modular structure which is simple, functional to use and versatile.

The above mentioned objects are achieved, in accordance with the contents of the claims, by a modular structure for furniture, including:

at least one tubular post, with a top and a bottom;

at least one cross-bar fastened, in the regions corresponding to its extremities, at the top of said at least one post;

with said post formed by a pair of channel-bars, with a series of longitudinal grooves made in said channel-bars;

with joining means engaging said longitudinal grooves at the top and at the bottom of the post, to hold said channel bars secured to each other and disposed so that one faces the other; and

with said cross-bar forming one of said joining means and being fastened at the top of said post by engaging said grooves of said post.

### BRIEF DESCRIPTION OF THE DRAWINGS

The invention will now be described in more detail with reference to particular, non-limiting embodiments and with reference to the accompanying drawings, in which:

FIG. 1 shows a partial front view of a modular structure for furniture subject of the present invention;

FIG. 2 shows a side view corresponding to the structure shown in FIG. 1;

FIG. 3 shows an enlarged view of the detail L of FIG. 2;

FIGS. 4 and 5 show corresponding views along lines IV-IV and V-V of FIG. 3;

FIG. 6 shows a cross-sectional view as seen along the line VI-VI of FIG. 2;

FIG. 7 shows a front enlarged view of a portion of the modular structure;

FIGS. 8A and 8B show an enlarged view of the detail M of FIG. 2 as indicated by the arrow A in FIG. 7;

FIG. 9 shows a bottom view of the same detail M;

FIG. 10 shows a cross-sectional view according to line X-X of FIG. 1;

FIG. 11 shows the same enlarged view of the detail M of FIG. 2, in a different employ configuration;

FIG. 12 shows a cross-sectional view according to line XII-XII of FIG. 8B;

FIG. 13 shows a schematic plan view of a different construction of an element of the modular structure;

FIG. 14 shows a perspective view of a piece of furniture obtained by means of the structure subject of the invention.

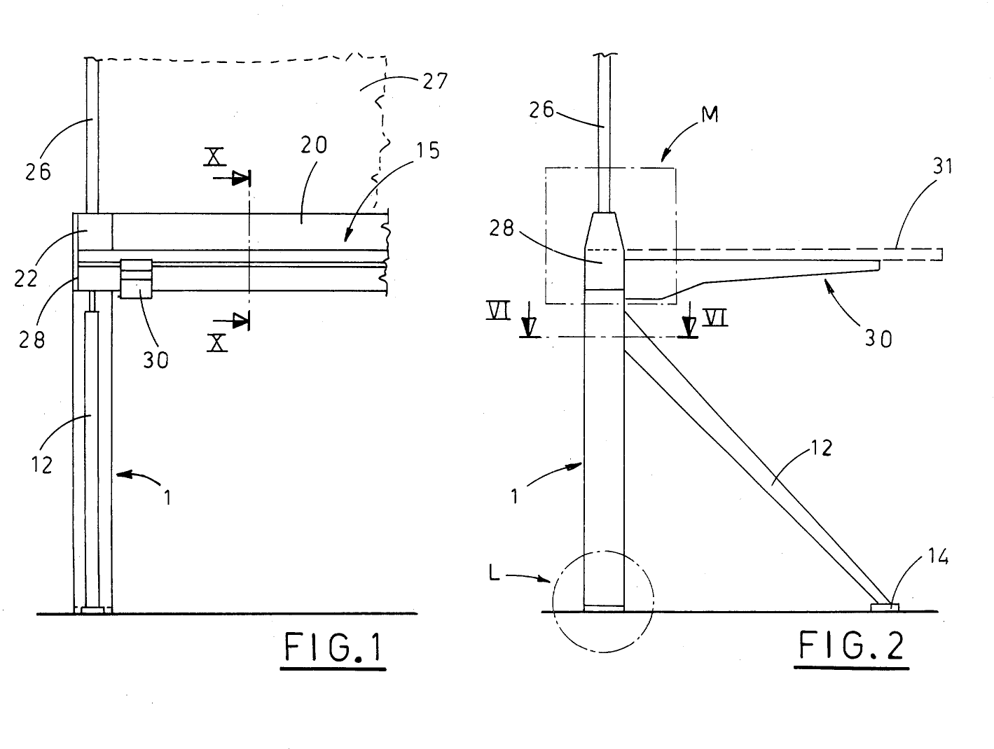

### DESCRIPTION OF THE PREFERRED EMBODIMENT

Having reference to the above mentioned Figures, the modular structure includes a tubular support post 1, with a top and a bottom, formed by a pair of channel-bars 2 disposed so that one faces the other and joined by joining means 7,15 better described below.

A pair of sides 3, which faces each other, are fastened to the post to close the resulting longitudinal openings. For this purpose, the sides 3 of the post 1 have, along their longitudinal borders, respective flanges 8 folded and suitably shaped, which have the task of elastically snap-engage the inner corners of the channel bars 2 (see FIG. 4).

The sides 3 may also feature a pair of longitudinal ribs, facing outwards, as illustrated with sketched line 9 in FIG. 4, so as to form a kind of guide, within which a wall 11 can fit.

The channel-bars 2 have a flat shape with a substantially rectangular outline and are preferably obtained from suitably shaped metallic tubular elements (see FIG. 4). The channel bars 2 have, in the wall facing the inside of the post 1, a pair of longitudinal grooves 4, situated symmetrical with reference to the middle axis, while in the wall facing outwards they have a further longitudinal groove 5 situated along the midline.

The grooves 4 and 5 have a substantially circular cross section.

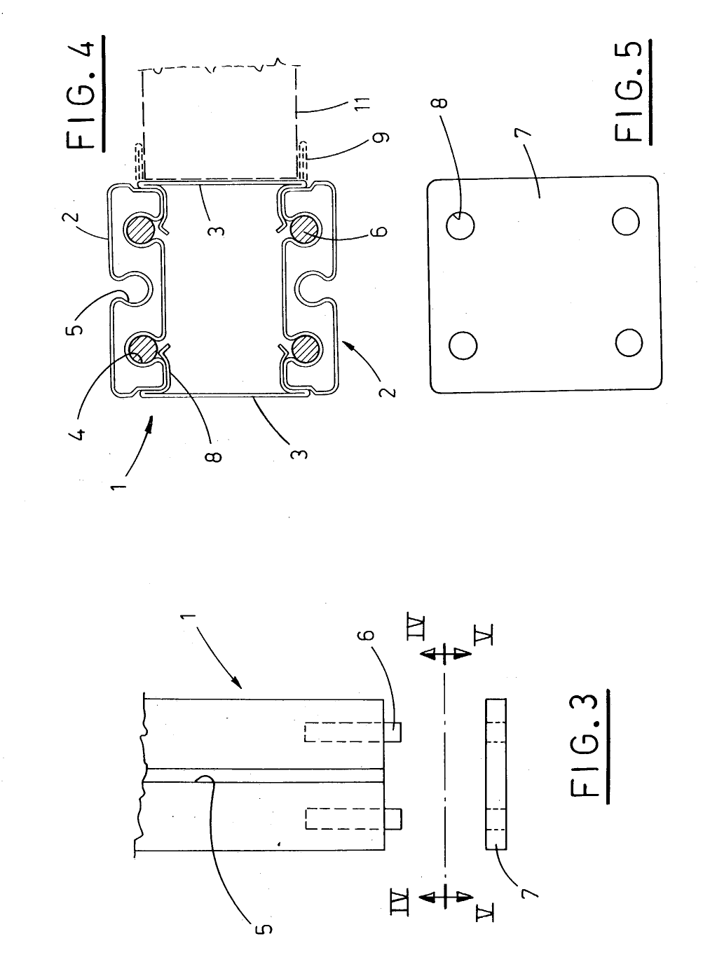

The inner groove 4 can be engaged at the bottom of the post by respective connection pegs 6, with a suitable interference fit, secured to a base plate 7. The base plate 7 includes a substantially squared plate having holes 8 for press-fitting the pegs 6 thereinto (see FIGS. 3 and 5).

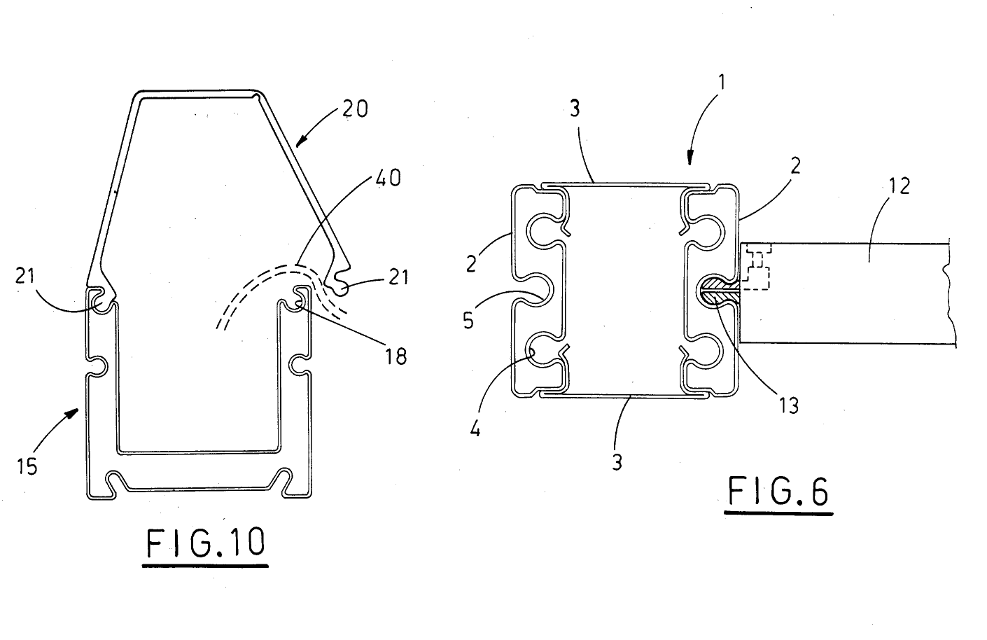

A support leg 12 can be connected to the post 1. The leg 12 extends diagonally starting from an upper part and has a resting base 14. The leg 12 is firmly connected to the post 1 by means of an expansion connection member 13, which fits into the external groove 5 of the post 1 and is operated by means of suitable tools (FIG. 6).

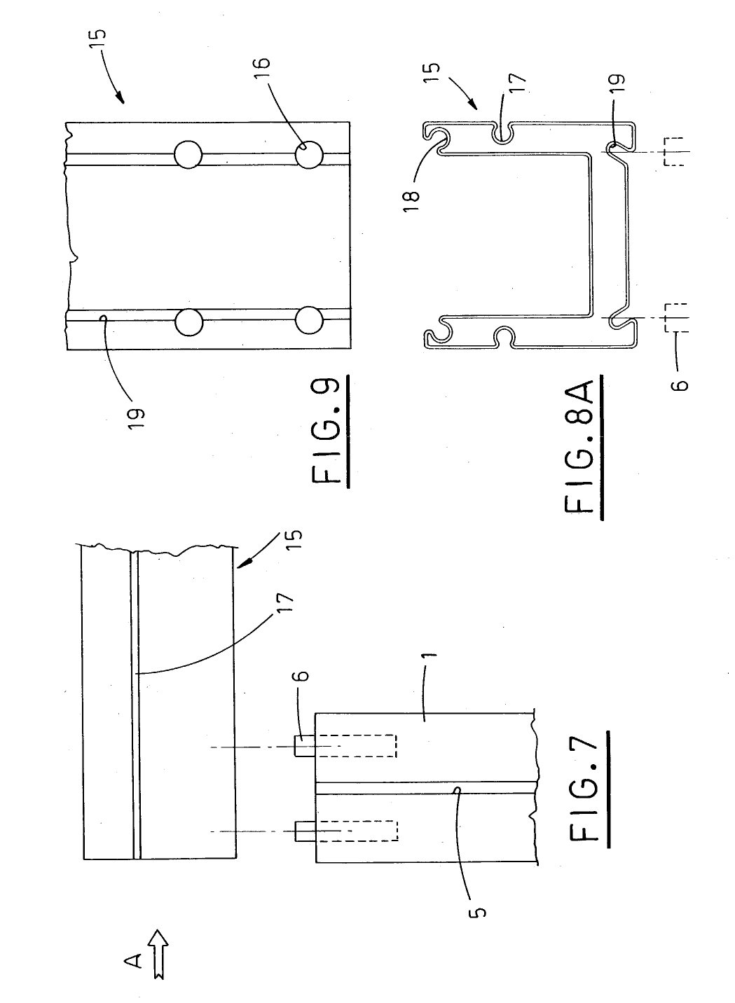

The modular structure include also a cross-bar 15, which, at the ends, can be connected to the top of the post 1(see FIG. 7). The cross-bar 15 is fastened to the post 1 by means of further pegs 6, which fit into the inner grooves 4 of the post 1 and into corresponding holes 16 made in the cross-bar 15 (FIG. 9). Thus, the base plate 7 and the cross-bar 15 form the above mentioned joining means.

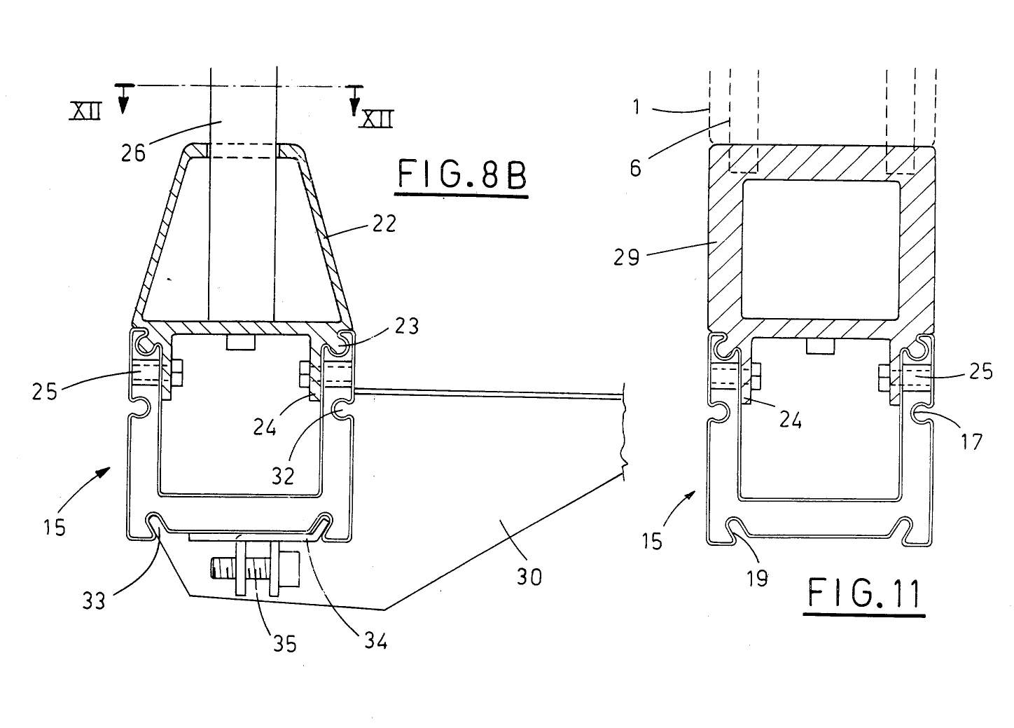

The cross-bar 15 is formed by a “U”-shaped bar with the open side turned upwards, so as to form a kind of channel (FIG. 8A). This “U”-shaped bar is preferably obtained from a tubular metallic element, which is suitably shaped.

The cross-bar 15 has a first pair of longitudinal grooves 17, made symmetrically in the outer surfaces, a second pair of longitudinal grooves 18 made along the inner corners of the upper edges, and a third pair of longitudinal grooves 19 made in the lower outer surface. The grooves 17 and 18 have a substantially circular cross-section, whereas the grooves 19 have a, elongated cross-section and are arranged at an angle with reference to the lower outer surface.

The kind of channel formed by the cross-bar 15 is closed at top by means of a cover element 20, preferably with a trapezoidal cross-section (see FIG. 10). The cover element 20 has longitudinal ribs 21 made along the longitudinal edges, which ribs are so shaped as to fit respectively into the upper grooves 18 of the cross-bar 15.

A joint member 22, formed by a kind of cap having trapezoidal cross-section similar to the cross-section of the cover element 20, is fastened to the top part of the cross-bar 15, in the regions corresponding to the extremities (see FIG. 8B). This cap 22 has ribs 23, which are capable of fitting into the upper grooves 18 of the cross-bar 15, and a pair of extensions 24, so arranged as to face each other, which are aimed at inserting into the recess delimited by the cross-bar 15 and at being secured to the surfaces of the cross-bar 15, by means of suitable screw means 25.

The joint member 22 defines a receiving seat for inserting therein a grooved upright 26, which has the task of forming a guide for insertion of a wall 27.

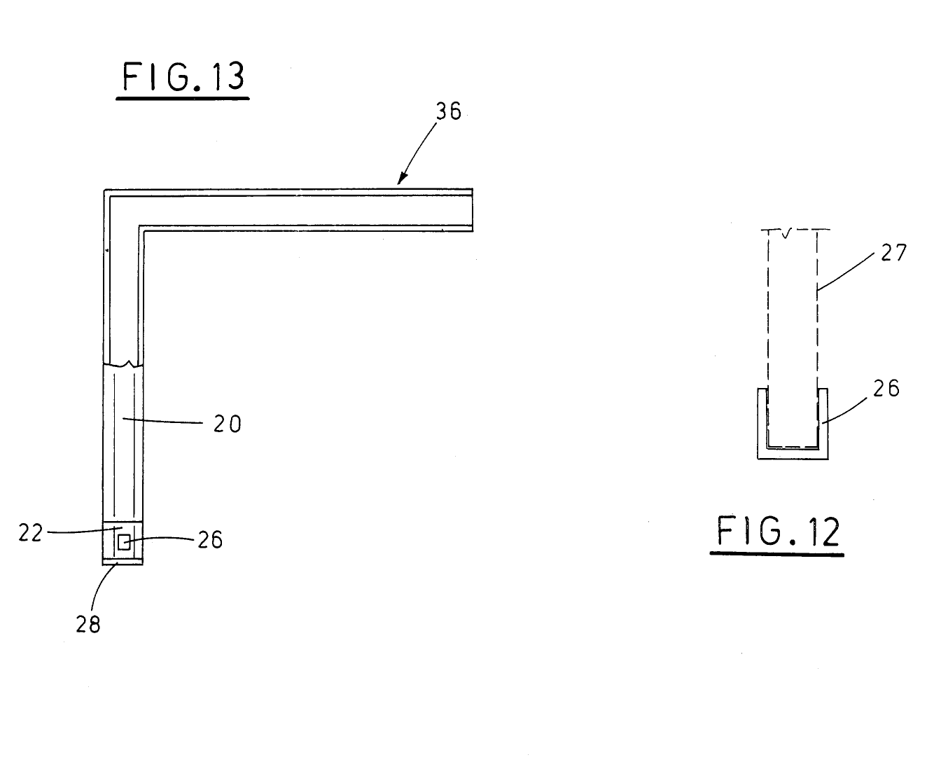

The upright 26 is formed, for example, by a channel “C”-shaped bar (see FIG. 12). It is anyway possible the provision of a “H”-shaped bar or a bar shaped in other way, in case two adjacent walls, for example, are to be associated to the structure.

The cross-bar 15 and the joint member 22, connected to each other, are closed at the side by means of a cover plate 28, whose profile is shaped as the outline of these elements.

As an alternative, another similar support post 1 can be joined to the cross-bar 15, right above the lower support post 1, by means of a joint member 29 having suitable shape, which permits fitting the above mentioned connection pegs 6 therein (FIG. 11).

A bracket 30 can also be connected to the cross-bar 15, for supporting a surface 31, which is part of the piece of furniture. In order to allow the connection with the cross-bar 15, the bracket 30 has projections 32,33 which are aimed at entering the grooves 17, 19 respectively (see again FIG. 8B). To lock the bracket 30, a clamp 34 is provided, which also engages with the groove 19 opposite to the one in which the projection 33 of the bracket enters. The clamp 34 is operated by means of a screw 35.

Obviously, the cross-bar connected to the post 1 can be produced with a different configuration in accordance with the different necessities of use. For example, in FIG. 13, the numeral reference 36 indicates a square-angled cross-bar.

The modular structure herein described allows a wide variety of modular furniture to be assembled.

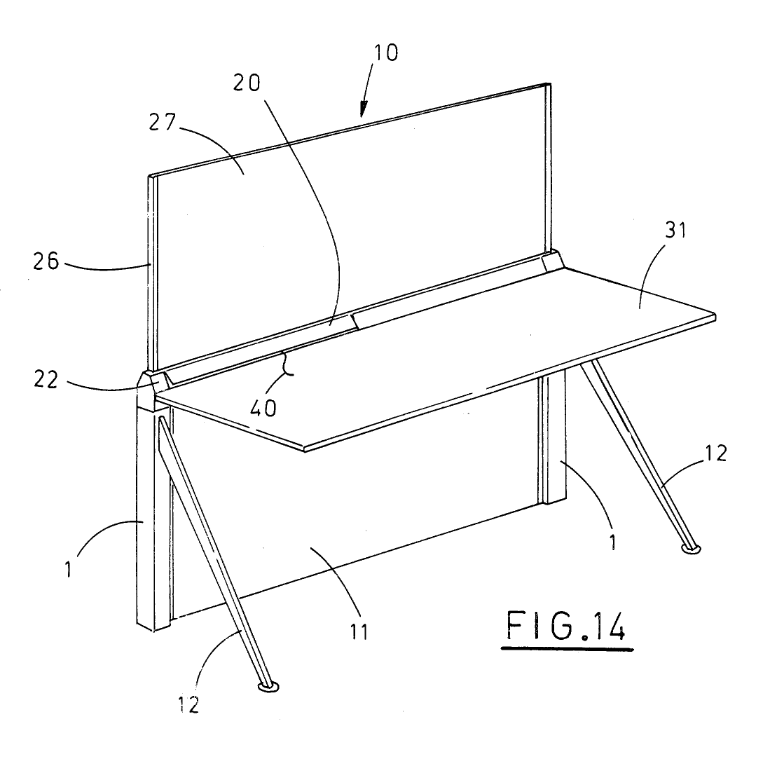

FIG. 14 shows an example of work station 10 obtained by means of a pair of posts 1, connected at top to each other by means of a cross-bar 15. In this case, the cross-bar 15 bears a working surface 31 by means of a pair of brackets 30.

Respective grooved uprights 26 extend vertically from the posts, to which they are connected by means of respective joint members 22. An upper wall 27 is inserted into the grooves of the uprights.

A lower closing wall 11 is directly fastened to the posts 1.

Obviously, the modular structure subject of the present invention allows variations of the configuration of the pieces of furniture, for instance by adding fittings and elements so as to form modular custom-designed furniture, as much as possible. In particular, square-angled work stations or double-angled work stations with a separation wall can be assembled, as well as isolated stations or the like. It is also possible the arrangement of many work stations disposed in a series.

A particular characteristic of the structure subject of the present invention is that the posts 1 and the cross-bars 15 have tubular shape, and their inside spaces can be set into communication with one another.

Therefore, conventional power cords 40 necessary for operation of electrical devices can be placed inside the posts 1 and the cross-bars 15, thus obtaining the advantage of a tidy and clean work station. The power cords 40 may exit from the cover element 20 at any desired position of the cross-bars 15 (see FIG. 10). Possibly, suitable holes can be made in the same cover element.

Another advantage deriving from the modular structure subject of the present invention derives from the fact that it results to be very easy to assemble. The various components are, in fact, easily connected to one another, mainly by snap fitting or matching parts thereof, using the grooves made in the posts 1 and in the cross-bars 15 and with a limited number of screw means.

What is claimed is:

1. In a modular structure for furniture, including:
at least one tubular post, with a top and a bottom;
at least one cross-bar fastened, in the regions corresponding to its extremities, at the top of said at least one post;
said post is formed by a pair of channel-bars, with a series of longitudinal grooves made in said channel-bars;
joining means engage said longitudinal grooves at the top and at the bottom of the post, to hold said channel bars secured to each other and disposed so that one faces the other; and
said cross-bar forms one of said joining means and is fastened at the top of said post by engaging said grooves of said post.

2. A modular structure according to claim 1, wherein said channel-bars have a flat shape with a substantially rectangular outline and are obtained from suitably shaped metallic tubular elements.

3. A modular structure according to claim 1, wherein said channel-bars have, in a wall facing the inside of the post, a pair of longitudinal grooves, situated symmetrical with reference to a middle axis, while on a wall facing outwards said channel-bars have a further midline longitudinal groove.

4. A modular structure according to claim 3, wherein said symmetrical longitudinal grooves have a substantially circular cross-section.

5. A modular structure according to claim 1, wherein each said post has counter-facing sides provided with a pair of folded longitudinal flanges snap-fitting in between the inner corners of said channel-bars.

6. A modular structure according to claim 1, wherein said sides have a pair of longitudinal ribs, facing outwards, to form a kind of guide, within which a closing wall can be introduced.

7. A modular structure according to claim 1, wherein said cross bar is connected to the top of said post by means of connection pegs fitting into said grooves, and said joining means include also a base plate fasted at the bottom of the post by means of connection pegs engaging said grooves of said post.

8. A modular structure according to claim 1, wherein said cross-bar is formed by a “U”-shaped bar with an open side turned upwards, so as to form a channel closed at top by a cover element.

9. A modular structure according to claim 8, wherein said cross-bar has a first pair of longitudinal grooves, situated symmetrically along outer surfaces, a second pair of longitudinal grooves made along inner corners of upper edges of the cross-bar, and a third pair of longitudinal grooves made in a lower outer surface.

10. A modular structure according to claim 9, wherein said cover element has longitudinal ribs made along its longitudinal edges, which ribs being capable of fitting respectively into a pair of longitudinal grooves made along upper edges of the cross-bar.

11. A modular structure according to claim 10, wherein said cover element has trapezoidal cross-section.

12. A modular structure according to claim 9, wherein said cover element leaves regions corresponding to extremities of the same cross-bar free, and a joint member is connected to said cross-bar in each of said regions corresponding to the extremities of the same cross-bar, which joint member defines a receiving seat for inserting therein a grooved upright, which has the task of forming a guide for insertion of a wall.

13. A modular structure according to claim 12, wherein said joint member is formed by a kind of a cap having longitudinal ribs, which are capable of fitting into a pair of longitudinal upper grooves made along upper edges of said cross-bar, and a pair of extensions facing each other, which extensions are capable of inserting into a recess delimited by the cross-bar and being secured to the surfaces of the cross-bar, by means of suitable screw means.

14. A modular structure according to claim 13, wherein said joint member has trapezoidal cross-section similar to the cross-section of said cover element of the cross-bar.

15. A modular structure according to claim 12, wherein said cross-bar and joint member connected to each other, are closed at the side by means of a cover plate having profile shaped like the outline of said cross-bar and joint member.

16. A modular structure according to claim 1, wherein said channel-bars have a further longitudinal groove made in the outer walls of the channel-bars and a support leg, extending diagonally from an upper part of said post, is connected to the post by means of a connection member engaging the above mentioned external groove of the same post.

17. A modular structure according to claim 1, wherein said longitudinal grooves, for connection of said joining means are made in inner walls of the channel-bars.

18. A modular structure according to claim 1, wherein it further includes at least one bracket for supporting a working surface and fastened at bottom of said cross-bar.

19. A modular structure according to claim 18, wherein said bracket has projections which enter corresponding longitudinal grooves made in said cross-bar in an outer side surface and on an outer lower surface respectively.

20. A modular structure according to claim 19, wherein said bracket is secured to said cross-bar by means of a clamp.

21. A modular structure according to claim 20, wherein said securing clamp engages a groove situated on an opposite position with reference to said groove into which said projection of the said bracket fits.

22. A modular structure according to claim 1, wherein said cross-bar is shaped to form an angle.
